(19) United States
(12) Patent Application Publication
(10) Pub. No.: US 2024/0055638 A1
(43) Pub. Date: Feb. 15, 2024

(54) GLASSY ORGANIC FRAMEWORK ION-CONDUCTIVE MEMBRANES

(71) Applicant: Wisconsin Alumni Research Foundation, Madison, WI (US)

(72) Inventors: Wenjie Li, Ithaca, NY (US); Dawei Feng, Madison, WI (US); Patrick Sullivan, Madison, WI (US); Xiuliang Lyu, Madison, WI (US)

(21) Appl. No.: 18/366,989

(22) Filed: Aug. 8, 2023

Related U.S. Application Data
(60) Provisional application No. 63/371,152, filed on Aug. 11, 2022.

(51) Int. Cl. H01M 8/103; C08G 61/12; C08J 5/22; H01M 8/18

(52) U.S. Cl. CPC H01M 8/103; C08G 61/122; C08J 5/2287; H01M 8/188; C08G 2261/124; C08G 2261/17; C08G 2261/312; C08G 2261/3221; C08G 2261/3241; C08G 2261/42; C08G 2261/722; C08J 2365/02; H01M 2300/0082

(57) ABSTRACT

Ion-conductive membranes composed of glassy organic frameworks are provided. Also provided are devices incorporating the ion-conductive membranes and methods of making the ion-conductive membranes. The glassy organic framework membranes can be synthesized from nitrile- and/or acetyl-group containing monomers using thermally controlled, step-wise nitrile and/or acetyl trimerization reactions and film casting techniques.

### CROSS-REFERENCE TO RELATED APPLICATIONS

The present application claims priority to U.S. provisional patent application number 63/371,152 that was filed August 11, 2022, the entire contents of which are incorporated herein by reference.

### BACKGROUND

A key problem associated with electrochemical cells is unwanted electrolyte crossover through the ion-conductive membrane separating different phases or different solutions, such as anolyte and catholyte solutions. This problem arises from the relatively large ion conductive channels in state-of-the-art polymeric ion exchange membranes and the relatively small size differences between the redox species/products and the charge balancing ions in electrolyte solutions. This unwanted crossover leads to electrochemical cells having undesired mixing of chemical species involved in the electrochemical processes and accelerated performance degradation, including a fast capacity decay and low energy efficiencies for batteries. For conventional amorphous polymer membranes, this problem is exacerbated in liquid electrochemical cells as the membrane structures/pores swell in aqueous media and may even dissolve in organic solvent, resulting in expedited crossover. This is particularly troublesome for separation and extraction applications.

In addition, electrochemical, thermal, and chemical degradation have proven to be problems for conventional ion exchange membranes, which further reduce the useful electrochemical cell lifetime.

Although various attempts have been made to design ion-conductive membranes that address the aforementioned problems, none of these attempts has produced a membrane that has low cost of production, high stability in a variety of solution conditions, selective ion transport, and high ion-conductivity.

### SUMMARY

Ion-conductive membranes composed of glassy organic frameworks (GOFs) are provided. Also provided are devices incorporating the GOF ion-conductive membranes (GOFIMs) and methods of making the GOFIMs. GOFIMs that are stable against degradation in various environments, including in aqueous and/or non-aqueous solutions, and/or in basic neutral, and/or acidic solutions, can be formed.

One embodiment of an electrochemical cell includes: (a) an anode; (b) a first electrolyte solution comprising redox inactive ions, redox active ions, or a mixture thereof; (c) a cathode; (d) a second electrolyte solution comprising redox inactive ions, redox active ions, or a mixture thereof and (e) at least one ion-conductive membrane comprising a continuous, unitary, homogeneous sheet of a glassy organic framework, the at least one ion-conductive membrane separating (a) and (b), separating (b) and (d), or separating and (c) and (d), the glassy organic framework comprising a network of covalently bonded aromatic rings, wherein the aromatic rings comprise phenylene rings, 1,3,5-triazine rings, pyridine rings, pyrimidine rings, or a combination of two or more thereof.

One embodiment of a method of making an ion-conductive membrane includes the steps of: (a) dissolving monomers in a trimerization reaction catalyst to form a solution, the monomers comprising: a nitrile monomer having one or more nitrile groups; an acetyl monomer having one or more acetyl groups; a monomer having at least one nitrile group and at least one acetyl group; a nitrogen-containing aromatic heterocyclic monomer comprising a functional group on a ring nitrogen atom in addition to at least two nitrile functional groups; or a combination of two or more thereof, and, optionally, a charged monofunctional dopant monomer comprising a single nitrile group or a single acetyl group, wherein the monomers react to form intermediates dissolved in the solution; (b) forming a film of the solution on a surface of a substrate; and (c) heating the film to induce a reaction of the intermediates to form the ion-conductive membrane comprising a continuous, unitary, homogeneous sheet of a glassy organic framework comprising a network of covalently bonded phenylene rings, 1,3,5-triazine rings, pyridine rings, pyrimidine rings, or a combination thereof.

One embodiment of a method of making an ion-conductive membrane includes the steps of: (a) conducting a nucleophilic aromatic substitution reaction between a halogenated aromatic monomer having at least two nitrile functional groups and a thiol compound to form a thiolated aromatic monomer having at least two nitrile functional groups; (b) dissolving the thiolated aromatic monomer in a trimerization reaction catalyst to form a solution, wherein the thiolated aromatic monomers react to form intermediates that are soluble in the solution; (c) forming a film of the solution on a surface of a substrate; and (d) heating the film to induce a reaction of the intermediates to form a membrane comprising a sheet of glassy organic framework comprising a thiolated network of covalently bonded 1,3,5-triazine rings.

One embodiment of a method of making a charged ion-conductive membrane includes the steps of: sulfonating phenyl rings in an amorphous organic framework comprising a network of covalently bonded phenylene rings; and deprotonating the sulfonate groups.

One embodiment of a method of making a charged ion-conductive membrane includes the steps of: chloromethylating phenyl rings in an amorphous organic framework comprising a network of covalently bonded phenylene rings; and reacting the chloromethyl groups with a tertiary amine to convert the chloromethyl groups into quaternary ammonium groups.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 shows the glassy structure of a GOF formed from bonded phenylene groups.

FIG. 2 shows the structures of alkane dinitriles, 2,4,6-tricyano-1,3,5-triazine, 1,3,5-tricyanobenzene, butanedinitrile, perfluoroterephthalonitrile, perchloroterephthalonitrile, 1,2,3-propanetricarbonitrile, 2-methylglutaronitrile, 3,3-bis(cyanomethyl)pentanedinitrile, 1,4-benzenedicarbonitrile, [1,1′-biphenyl]-4,4′-dicarbonitrile, 1,4-phenylenediacetonitrile, 2,2′-([1,1′-biphenyl]-4,4′-diyl)diacetonitrile, and 9H-carbazole-3,6-dicarbonitrile monomers.

FIG. 3 shows the structures of aromatic nitrile monomers containing multiple phenylene rings, at least some of which are connected by ether groups, with fluorine substituents on at least some of the phenylene rings.

FIG. 4 shows the structures of aliphatic alkane diones (e.g., butanedione, 2,3-pentanedione, 2,3-hexanedione, 3,4-hexanedione, and 2,5-hexanedione), cycloaliphatic diones (e.g., 1,4-cyclohexancedione and 1,3-cyclohexanedione), 1,3,5-cyclohexancetrione, 1,3-cyclopentanedione, 2,6-diacetylpyridine, 1-(1,4-phenylene)bis-ethanone, 4-acetoxy-4′-acetylbiphenyl, and 1,3,5-triacetylbenzene monomers.

FIG. 5 shows the structures of two mixed acetyl nitrile monomers that include at least one acetyl group and at least on nitrile group.

FIG. 6A shows the structures of three mono-nitrile monomers. FIG. 6B shows the structures of three mono-acetyl monomers.

FIG. 7 shows a step-wise condensation reaction scheme for the synthesis of an GOFIM.

FIG. 8 shows macrocycles formed within larger GOFs to illustrate the ability to tune the average pore size in a neutral (uncharged) GOF through the selection of starting monomers.

FIG. 9 shows macrocycles formed within larger GOFs to illustrate the ability to tune the pore surface polarity in a neutral GOF through the selection of starting monomers.

FIG. 10 shows a charged macrocycle formed within a larger GOF made using a pre-functionalized 9H-carbazole-3,6-dicarbonitrile monomer bearing a charged substituent on its ring nitrogen atom.

FIG. 11 shows an alternative scheme for forming a neutral or negative charge-bearing GOF.

FIG. 12 shows a reaction scheme for the functionalization of aromatic rings in a GOF with sulfonate groups.

FIG. 13 shows an alternative reaction scheme for the functionalization of aromatic rings in GOF with sulfonate groups.

FIG. 14 shows another reaction scheme for the functionalization of the aromatic rings in a GOF that takes advantage of the use of monomers that include a combination of nitrile and acetyl groups, either on the same monomer or on two or more different monomers in a monomer mixture.

FIGS. 15A and 15B show the use of charged dopant monomers to tailor the average pore size and charge density of a GOF using either nitrile monomers (FIG. 15A) or acetyl monomers (FIG. 15B).

FIG. 16 illustrates the use of a double layered free-standing membrane that includes a first layer of a GOF having a relatively large average pore size adjacent to, and covalently crosslinked with, a second layer of a GOF having a smaller average pore size.

FIG. 17 shows a bipolar GOFIM (bp-GOFIM) that includes an anion exchange layer (AEL) composed of an anion-conductive GOFIM (a-GOFIM) and a cation exchange layer (CEL) composed of a cation-conductive GOFIM (c-COFIM) with water dissociation catalysts sandwiched at the interface.

FIG. 18 is a schematic diagram of one embodiment of an aqueous organic redox flow battery (AORFB) that includes an ion-selective membrane.

FIG. 19 shows the ion conductivity of neutral GOFIMs (n-GOFIMs) in different electrolytes measured using impedance spectroscopy.

FIG. 20 shows a comparison of battery cycling performances of GOFIMs and a commercial Daramic membrane applied in non-aqueous organic redox flow batteries.

### DETAILED DESCRIPTION

GOFIMs, devices incorporating the GOFIMs, and methods of making the GOFIMs are provided.

The GOFIMs can be synthesized from nitrile- and/or acetyl-group containing monomers using simple, thermally controlled, step-wise nitrile and/or acetyl trimerization reactions and film casting techniques. The choice of monomers and the option of functionalizing the membranes with charged functional groups provides for the control of membrane pore size, pore surface polarity, and charge density. As a result, the membrane ion-selectivity and ion-conductivity can be tailored to particular applications, including applications where nanopores with high ion selectivity are required. By way of illustration, membranes having an average pore size in the range from 0.1 to 5 nm, including in the range from 0.5 to 2 nm, can be synthesized.

The GOFIMs can be used in any devices and applications that rely on the size and/or charge-selective passage of ions. Such devices and applications include electrochemical cells, electrocatalysis cells, desalination cells, ion separation-based purification and recovery cells, water splitting, and chemical processes, such as catalysis. The membranes are particularly suited for use in electrochemical cells, such aqueous or non-aqueous redox flow batteries, where the minimization or elimination of electrolyte crossover is important.

The GOFIMs are composed of an amorphous (or “glassy”) organic framework comprising a network of covalently bonded aromatic rings. The aromatic rings that form the network include phenylene rings, 1,3,5-triazine rings, pyridine rings, pyrimidine rings, or combinations of two or more thereof. The membranes may include a single layer of a GOF, or may include two or more layers of different GOFs with covalent bonds between adjacent layers.

In contrast to crystalline covalent organic frameworks, which are typically provided as a powder or a powder-based coating on a support substrate, the GOFs are solution-processable and can readily form continuous unitary sheets of the GOFs, wherein the sheets have a homogenous chemical composition. As such, the membranes made in accordance with the methods described herein are distinguishable from membranes composed of conjugated polymer particles dispersed in a polymer binder because such membrane have a heterogeneous chemical composition. Moreover, the GOFs can be made in the form of free-standing membranes. As used herein, the term free-standing membrane refers to a continuous unitary sheet of material that does not require a support substrate to maintain its continuous unitary structure and that exists as a continuous unitary sheet without a support substrate or that can be removed from a support substrate and handled as a continuous unitary sheet. As such, the free-standing, ion-conductive membranes described herein are readily distinguishable from substrate-supported coatings composed of crystalline powders. It should be noted that, while the ion-conducting membranes may be formed as free-standing membranes, they may also be formed as sheets of the GOF on a support substrate.

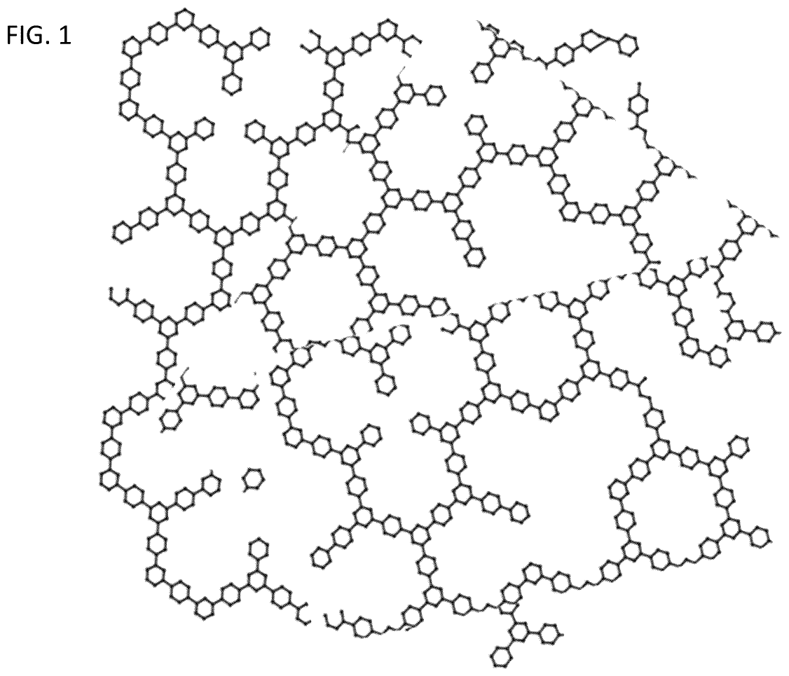

In the networks, the aromatic rings are covalently bonded in a disordered structure, in which aromatic rings may be directly covalently bonded to one another or may be covalently bonded to one another via bonding groups, such as alkane chains, alkene chains, and/or by carbazole groups. The alkane chains and alkene chains are typically short chains containing from one to ten carbon atoms in the chain. This includes alkane and alkene chains that contain from one to six carbon atoms and further includes alkane and alkene chains that contain from one to three carbon atoms in the chain. However, longer alkane and alkene chains can be used. The amorphous nature of the GOFs is illustrated in FIG. 1, which shows an example of a GOF formed from covalently bonded phenylene groups.

The ring atoms of the aromatic rings, the bonding groups connecting the aromatic rings, or both, can be functionalized with anionic or cationic substituents to provide the ion-conductive membranes with charge selectivity. Examples of anionic substituents with which the aromatic rings and/or bonding groups can be functionalized include sulfonate groups, phosphonate groups, and carbonate groups. Examples of cationic substituents with which the aromatic rings and/or bonding groups can be functionalized include quaternary ammonium groups and cationic nitrogen-containing heteroaromatic groups. Cationic charges can also be introduced in the GOFs by alkylating the ring nitrogen atom of a nitrogen-containing aromatic ring (for example, the nitrogen atom of a pyridine ring or a pyrimidine ring) to convert the nitrogen-containing aromatic ring into a cationic aromatic group.

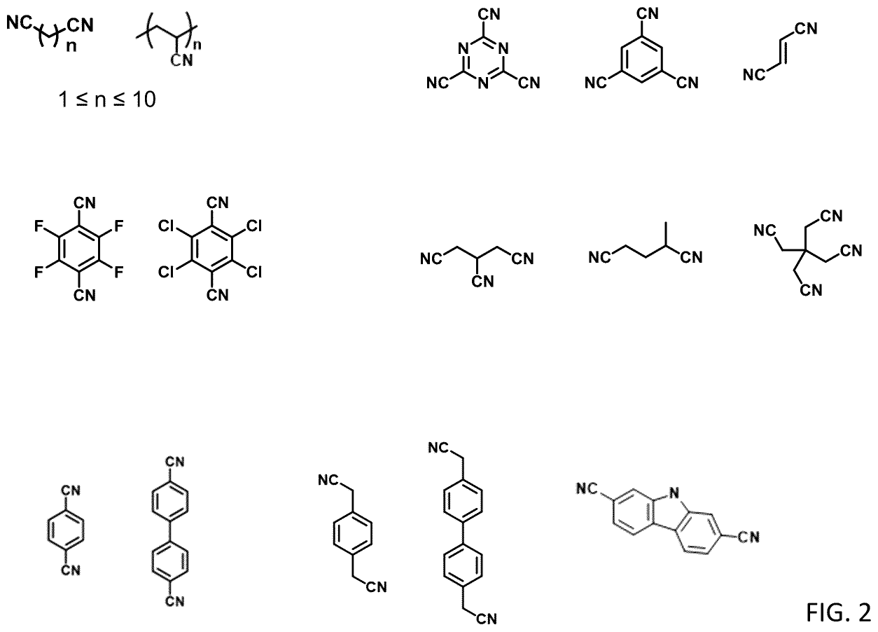

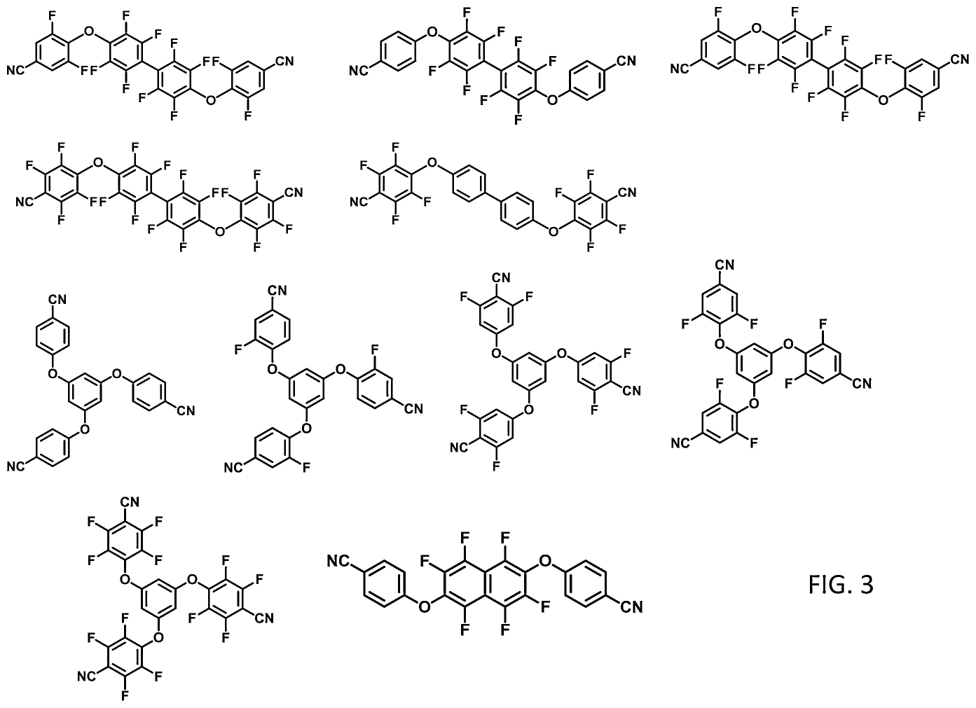

The GOFs can be made from a variety of nitrile monomers having two or more nitrile groups, acetyl monomers having two or more acetyl groups, mixed monomers having at least one nitrile group and at least one acetyl group in the same monomer, or a combination thereof. Examples of nitrile monomers include alkane dinitriles, 2,4,6-tricyano-1,3,5-triazine, 1,3,5-tricyanobenzene, butanedinitrile, perfluoroterephthalonitrile, perchloroterephthalonitrile, 1,2,3-propanetricarbonitrile, 2-methylglutaronitrile, 3,3-bis(cyanomethyl)pentanedinitrile, 1,4-benzenedicarbonitrile, [1,1′-biphenyl]-4,4′-dicarbonitrile, 1,4-phenylenediacetonitrile, 2,2′-([1,1′-biphenyl]-4,4′-diyl)diacetonitrile, and 9H-carbazole-3,6-dicarbonitrile, the structures of which are shown in FIG. 2. Other examples include aromatic nitrile monomers containing multiple phenylene rings, at least some of which are connected by ether groups, with fluorine substituents on at least some of the phenylene rings, as illustrated in the examples of FIG. 3.

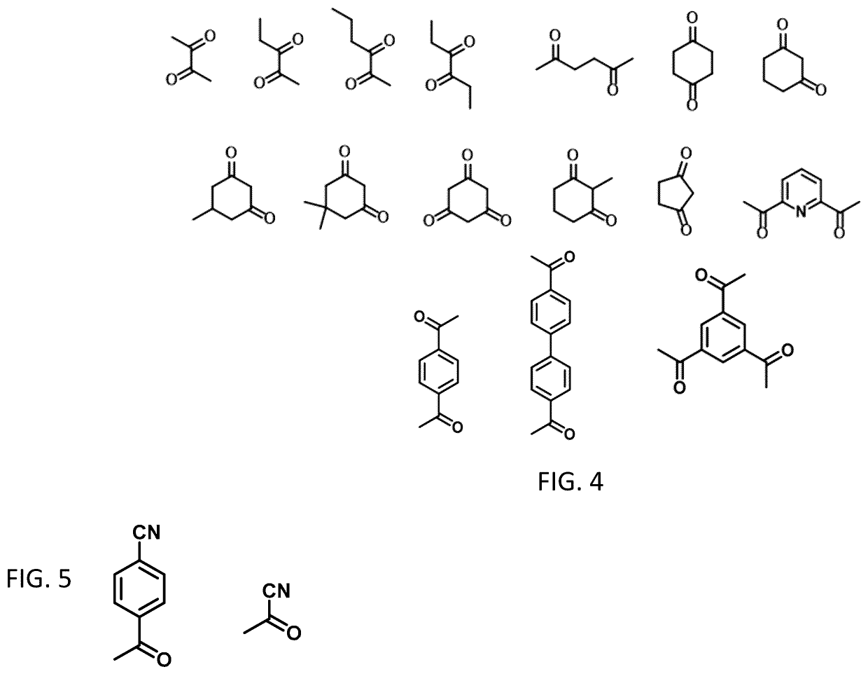

The acetyl monomers include aliphatic ketones, including cycloaliphatic ketones, having two or more carbonyl groups. Examples of these include alkane diones, such as butanedione, 2,3-pentanedione, 2,3-hexanedione, 3,4-hexanedione, 1,4-cyclohexancedione, 1,3-cyclohexanedione, 1,3,5-cyclohexancetrione, a 1,3-cyclopentanetrione, 2,6-and diacetylpyridine, 1-(1,4-phenylene)bis-ethanone, 4-acetoxy-4′-acetylbiphenyl, and 1,3,5-triacetylbenzene, the structures of which are shown in FIG. 4. As illustrated in FIG. 4, in some embodiments of the cycloaliphatic acetyl monomers, the ring has one or more alkyl (e.g., methyl) substituents.

Mixed acetyl nitrile monomers that include at least one acetyl group and at least one nitrile group include 4-acetylbenzonitrile and acetyl cyanide, the structures of which are shown in FIG. 5.

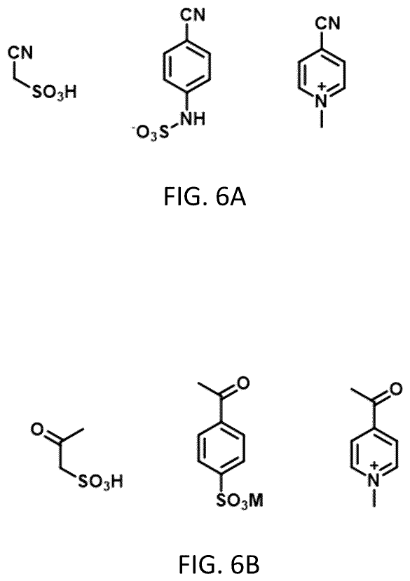

In addition to the nitrile monomers, acetyl monomers, and mixed acetyl nitrile monomers, monomers that have only a single acetyl group without any nitrile groups or that have only a single nitrile group without any acetyl groups can be used in the synthesis of the GOFs. These mono-acetyl or mono-nitrile monomers are used as dopants to introduce functional groups, including charged functional groups, into the network of covalently bonded aromatic rings in order to tailor the pore sizes within the GOF and/or to tailor the flexibility of the membranes. Mono-nitrile monomers include alkyl nitrile monomers in which the alkyl group has an anionic substituent, aryl nitrile monomers in which the aryl group has an anionic substituent, and cyano pyridinium monomers (e.g., 1-methyl-4-cyanopyridinium). Example mono-nitrile monomers are shown in FIG. 6A. Mono-acetyl monomers include acetyl monomers in which the alkyl group has an anionic substituent, aryl monomers in which the aryl group has an anionic substituent, and acetyl pyridinium monomers (e.g., 1-methyl-4-acetylpyridinium). Example mono-acetyl monomers are shown in FIG. 6B. (In FIGS. 6A and 6B, the “M” represents a charge-balancing cation, such as a metal ion.)

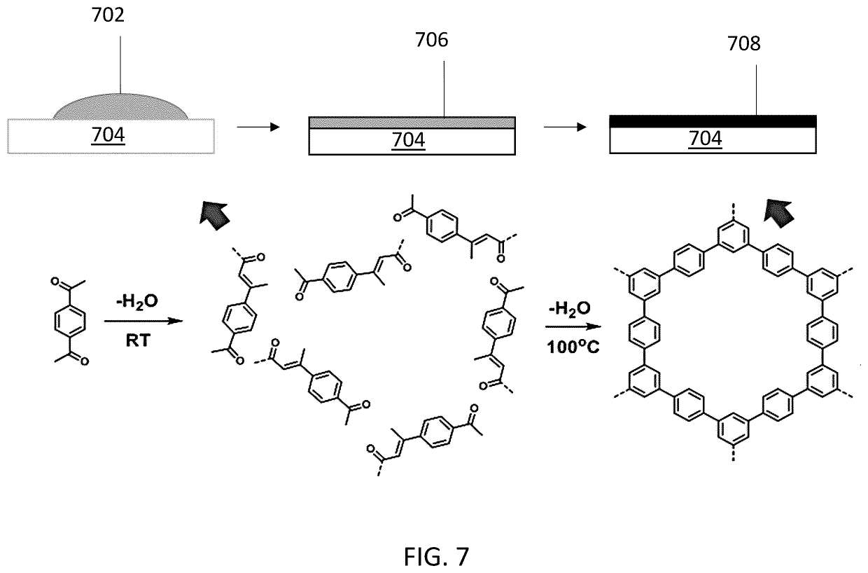

Step-wise condensation reactions involving soluble intermediates are used to synthesize a network of covalently bonded aromatic groups from the monomers. The reactions trimerize the nitrile and acetyl group-containing monomers to form the phenylene, triazine, pyridine, and/or pyrimidine rings that make up the backbone of the network. A step-wise condensation reaction scheme is shown schematically in FIG. 7. The syntheses utilize an organic solution 702 comprising a nitrile monomer having at least two nitrile groups, an acetyl monomer having at least two acetyl groups, a mixed monomer comprising at least one nitrile group and at least one acetyl group, or a combination of two or more such monomers, wherein the monomers are dissolved in a trimerization reaction catalyst. In a first step of the synthesis, the solution is formed and nitrile and/or acetyl groups of the monomers in the solution dimerize to form soluble intermediates. Mixing can be used to promote these first condensation reactions. This first condensation step is carried out at a first temperature. The first temperature may be room temperature (RT) (e.g., a temperature in the range from 21° C. to 24° C.) or may be a temperature that is elevated above room temperature. For example, temperatures of up to 100° C. may be used. Solution 702 is coated on a substrate 704 and spread into a viscous liquid film 706. The intermediates then undergo further condensation reactions in which the monomers trimerize to form the fused aromatic rings of the network, thereby converting viscous liquid film 706 into a free-standing membrane 708 comprising a GOF. A portion of the covalent network structure of the GOF forming a macrocycle is shown in the reaction scheme of FIG. 7 and the larger amorphous structure of the GOF in which the macrocycle is incorporated is shown schematically in FIG. 1. Thus, it should be understood that GOFs do not have a highly ordered crystalline structure and that, while macrocycles may be formed within the covalently bonded networks, not all of the aromatic rings will be incorporated into well-ordered macrocycles. The further condensation reactions are typically carried out a temperature that is higher than the temperature at which the initial condensation is carried out. By way of illustration, the second condensation step can be carried out at temperatures in the range from room temperature to 200° C. However, higher or lower temperatures can also be used depending on the selected monomers and desired rate of reaction progress. Free-standing membrane 708 can then be washed to remove the trimerization catalyst and peeled away from substrate 704. Suitable trimerization catalysts include, but are not limited to Brønsted acids, such as triflic acid, methanesulfonic acid, ethanesulfonic acid (i.e., R—SO₃H) and Lewis acidic ionic liquids.

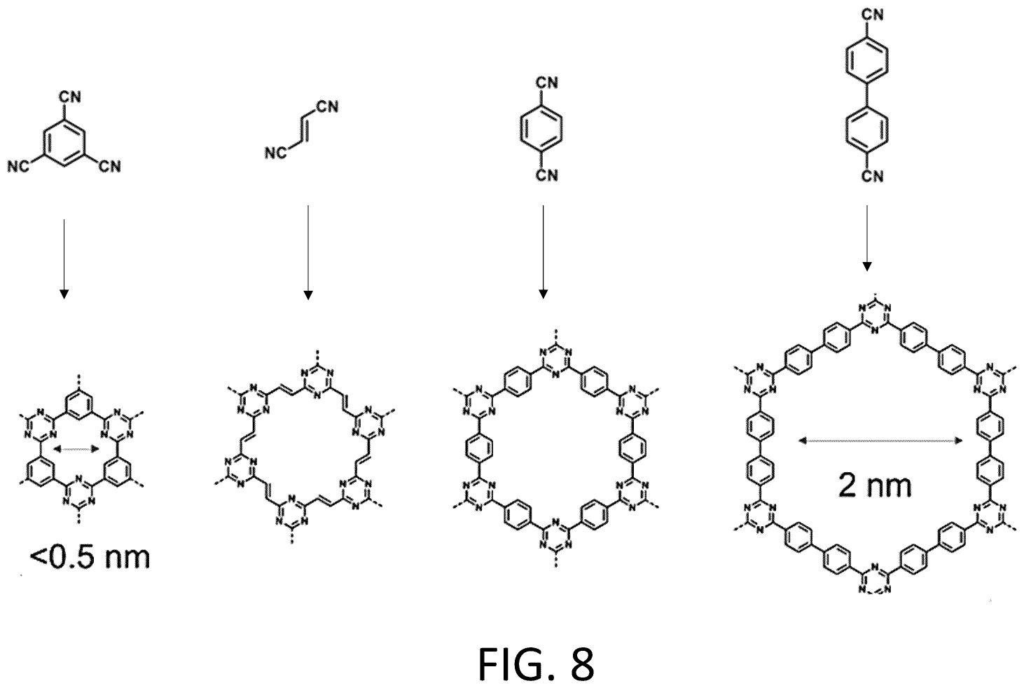

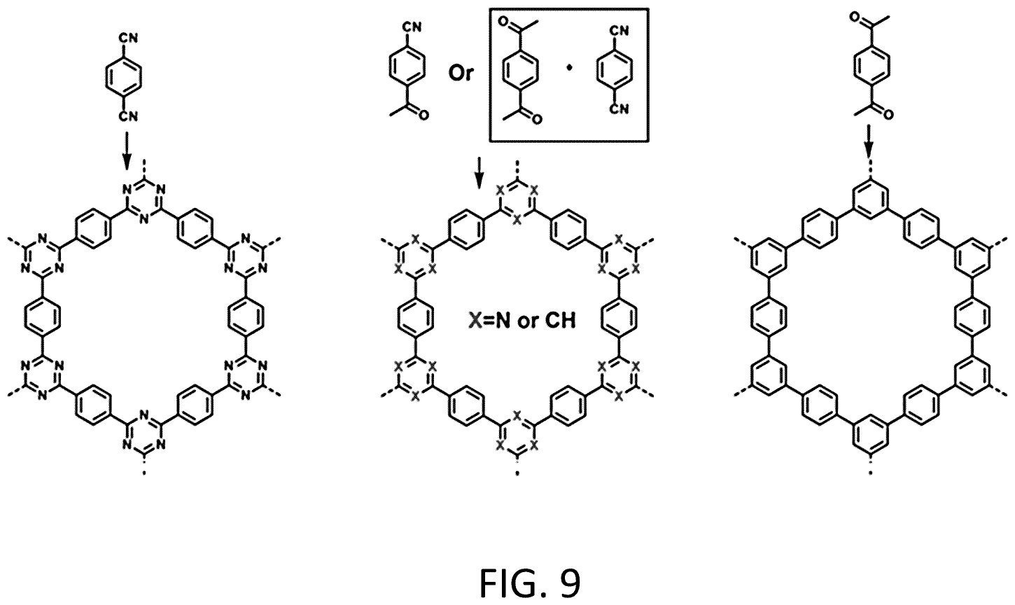

The step-wise condensation can be carried out with a single monomer or various combinations of monomers, including combinations of two, three, or more monomers of the types shown in FIGS. 2, 3, 4, 5, 6A, and 6B, in order to form a membrane having the desired pore size, pore surface polarity, charge state, and/or charge density. FIG. 8 shows macrocycles formed within larger GOFs to illustrate the ability to tune the average pore size in a neutral (uncharged) GOF through the selection of starting monomers. FIG. 9 shows macrocycles formed within larger GOFs to illustrate the ability to tune the pore surface polarity in a neutral GOF through the selection of starting monomers.

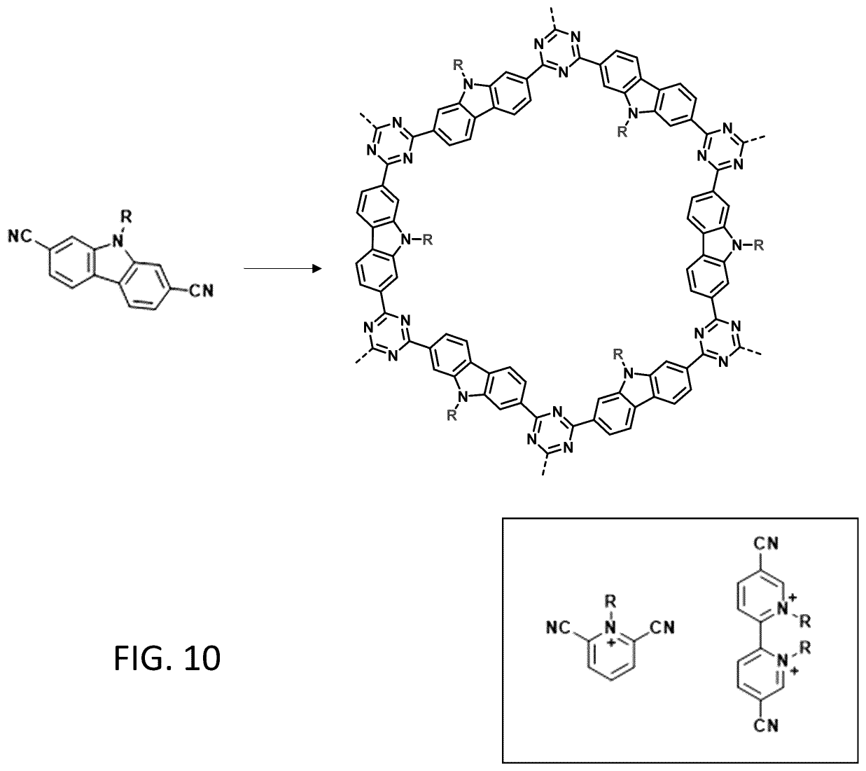

The charge state and charge density of a charged GOF can be tailored by incorporating pre-functionalized monomers bearing cationic or anionic groups into the GOF or by post-functionalizing a pre-formed GOF with charged groups. FIG. 10 shows a charged macrocycle formed within a larger GOF made using a pre-functionalized 9H-carbazole-3,6-dicarbonitrile monomer bearing a charged substituent on its ring nitrogen atom. The pre-functionalized 9H-carbazole-3,6-dicarbonitrile monomer is used for illustrative purposes only. Other nitrile and acetyl monomers that are pre-functionalized with charged substituents, including monomers having a pyridinium or bipyridinium group, can be used. These include 2,6-pyridiniumdicarbonitrile and 2,2′-bipyridinium-5,5′ dicarbonitrile (FIG. 10, inset). In FIG. 10, R is used to represent a generic anionic or cationic group. Examples of suitable anionic groups include sulfonate groups, phosphonate groups, and carbonate groups.

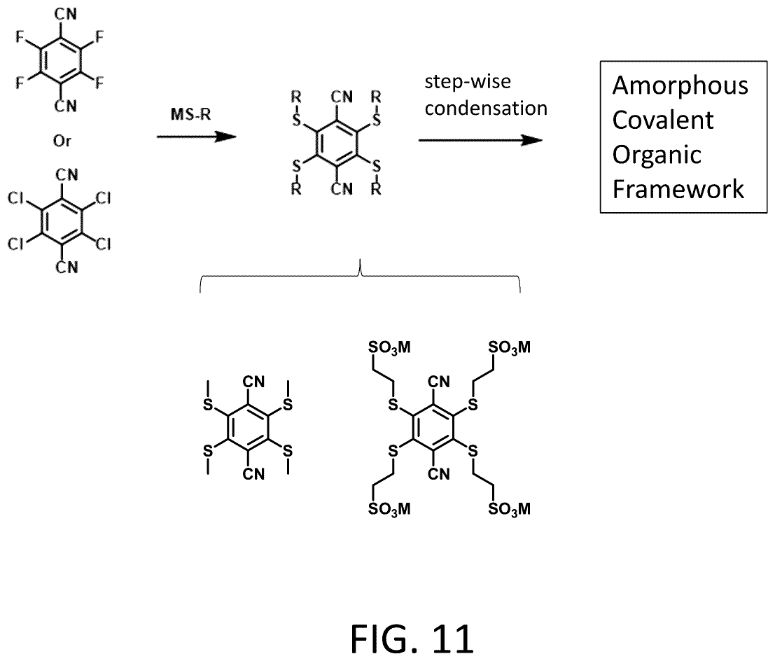

An alternative scheme for forming a neutral or negative charge-bearing GOF is shown in FIG. 11. This scheme begins with halogenated (e.g., fluorinated or chlorinated) aromatic nitrile monomers having at least two nitrile groups. A nucleophilic aromatic substitution reaction is carried out between the halogenated aromatic monomers and a thiol compound to form a thiolated aromatic monomer having at least two nitrile functional groups. The step-wise condensation reactions are then carried out to form the fused aromatic rings of the network. In FIG. 11, the M in the product on the right side represents a charge-balancing counterion, such as a metal ion. The nature of the functional groups on the thiolated monomers will depend on the particular thiol compound being used. Two illustrative thiolated monomers are shown in the figure, where the M in the thiolated monomer on the right side represents a charge-balancing counterion, such as a metal ion.

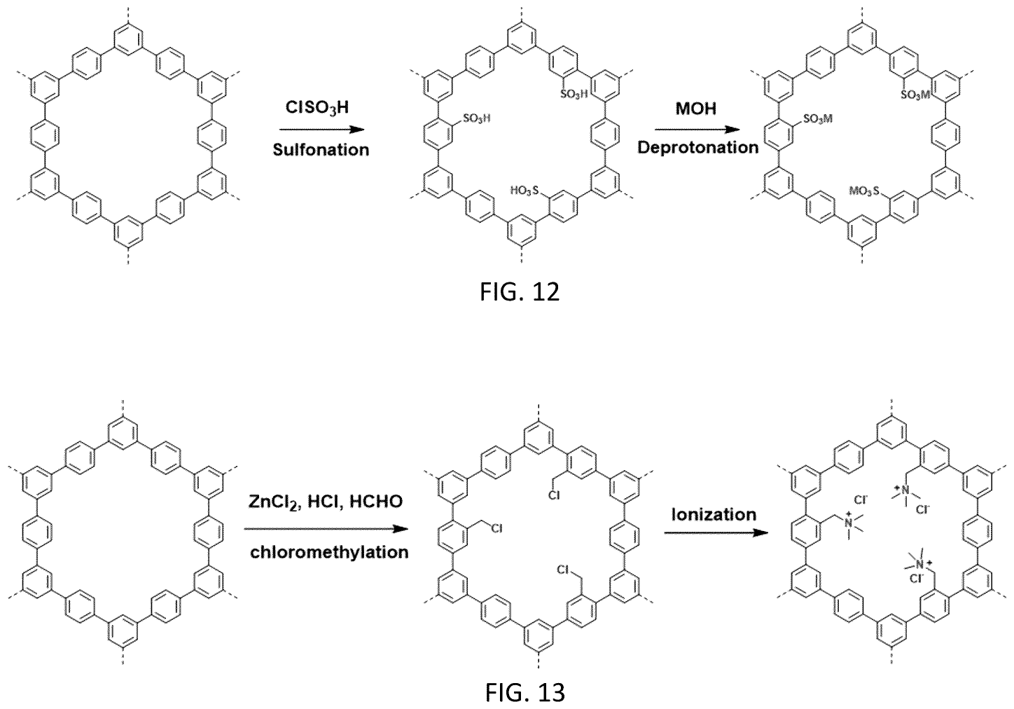

A reaction scheme for the post-synthesis functionalization of aromatic rings in a GOF with sulfonate groups is shown in FIG. 12. In this scheme, the phenyl rings in a GOF comprising a network of covalently bonded phenylene rings are sulfonated and subsequently deprotonated. (As in previous figures, the M represents a charge-balancing cation.)

An alternative reaction scheme for the post-synthesis functionalization of aromatic rings in GOF with sulfonate groups is shown in FIG. 13. In this scheme, phenyl rings in GOF comprising a network of covalently bonded phenylene rings are chloromethylated, and the chloromethyl groups on the rings are subsequently reacted with a tertiary amine to convert the chloromethyl groups into quaternary ammonium groups.

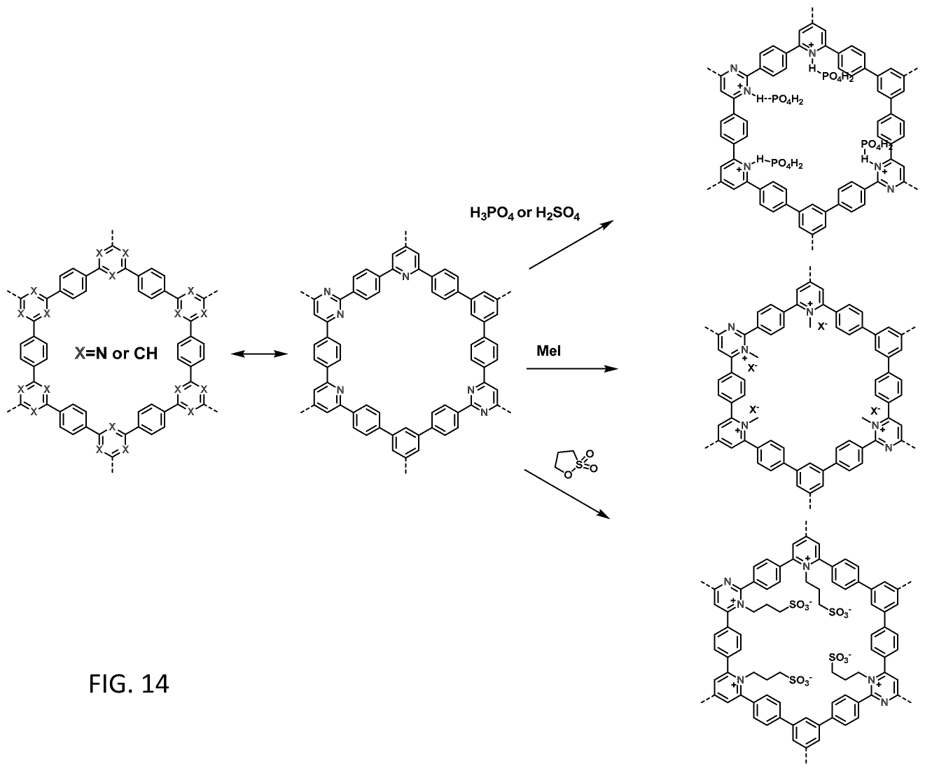

Yet another reaction scheme for the post-synthesis functionalization of the aromatic rings in GOF takes advantage of the use of monomers that include a combination of nitrile and acetyl groups, either on the same monomer or on two or more different monomers in a monomer mixture. This scheme is illustrated in FIG. 14. In the illustrative embodiment of FIG. 14, 4-acetylbenzonitrile monomers, acetyl cyanide monomers, or a mixture of thereof, or a mixture of 1,4-benzenedicarbonitrile and 1-(1,4-phenylene)bis-ethanone are used to form a network of covalently bonded phenylene, pyridine, pyrimidine, and triazine rings (left panel). In contrast to GOFs in which different aromatic rings are distributed in a pattern (e.g., ABABAB or ABBABBA) within the covalently bonded network, the different aromatic rings in a covalently bonded network made from mixed monomers may be randomly distributed. A portion of the network forming a macrocycle is depicted in the figure, illustrating a random distribution of phenylene, pyridine, and pyrimidine rings (center panel). The nitrogen atoms of the aromatic rings in the network can then be post-functionalized using various reaction schemes. For example, the ring nitrogen atoms of pyridine, pyrimidine, and/or triazine rings can be reacted with sulfuric acid or phosphoric acid to convert the nitrogen-containing heteroaromatic rings into cations that are associated with either a sulfate or phosphate anion. Thus, as illustrated in the upper right panel of FIG. 14, pyridinium dihydrogen phosphate groups and/or pyrimidinium dihydrogen phosphate groups can be introduced into the GOF. Similarly, pyridinium hydrogen sulfate groups and/or pyrimidinium hydrogen sulfate groups can be introduced into the GOF. Alternatively, the nitrogen atoms of the aromatic rings in the network can be post-functionalized via alkylation (e.g., methylation) reactions (center right panel). Yet another option for the post-functionalization of the GOFs is shown in the lower right panel of FIG. 14. In this scheme, the nitrogen atoms of the aromatic rings in the network are reacted with a cyclic sulfate, cyclic phosphate, and/or cyclic carbonate to functionalize the aromatic rings with sulfonate, phosphonate, or carbonate groups. It should be understood that mixed monomers other than those shown in FIG. 14 can be used and that the post-functionalization reactions shown in FIG. 14 can be carried out on GOFs made using other types of monomers, provided that the GOF includes nitrogen-containing heteroaromatic of heterocyclic rings.

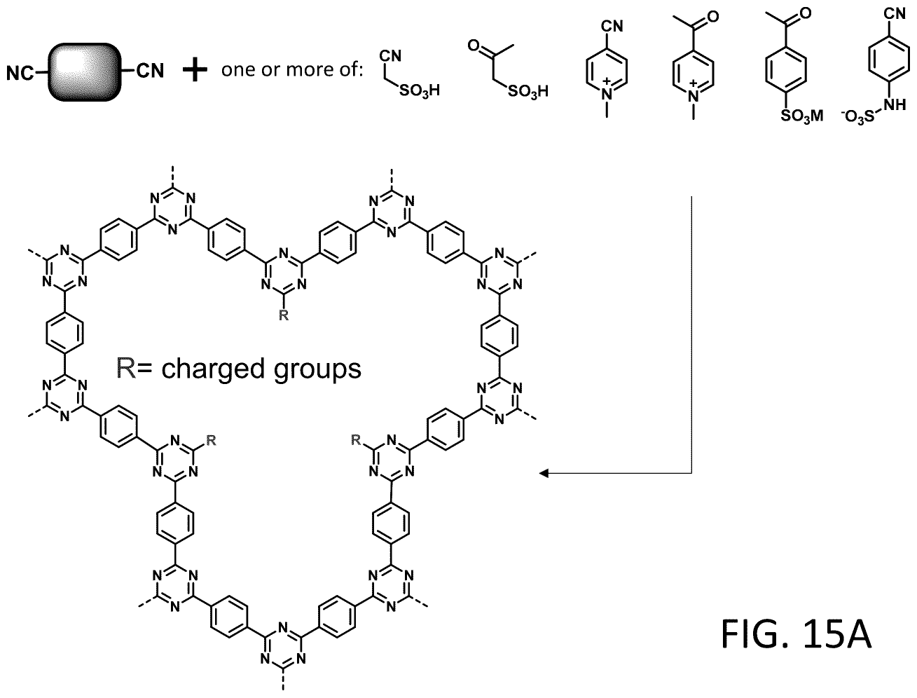

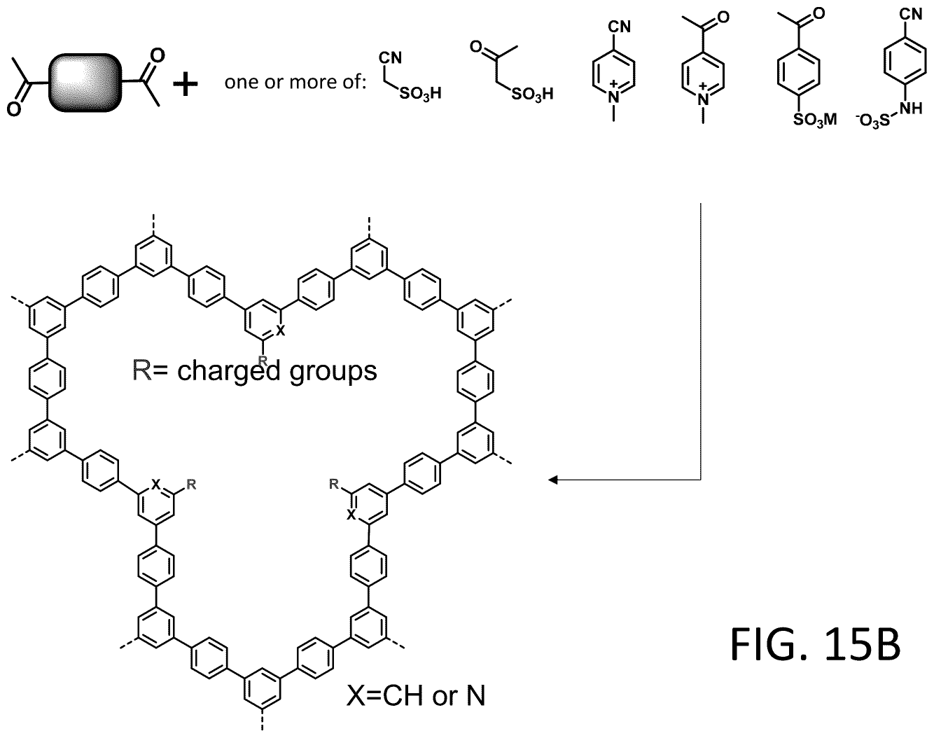

The use of charged dopant monomers to tailor the average pore size and charge density of a GOF is illustrated in FIGS. 15A and 15B, using either nitrile monomers (FIG. 15A) or acetyl monomers (FIG. 15B). In the figure, generic monomers having either two nitrile groups or two acetyl groups are shown at the top, using a gray box to represent the body of the monomer. As in previous figures, R is used to represent a generic anionic or cationic group. Examples of suitable anionic groups include sulfonate groups, phosphonate groups, and carbonate groups, and suitable cationic groups include quaternary ammonium groups and cationic nitrogen-containing heteroaromatic groups.

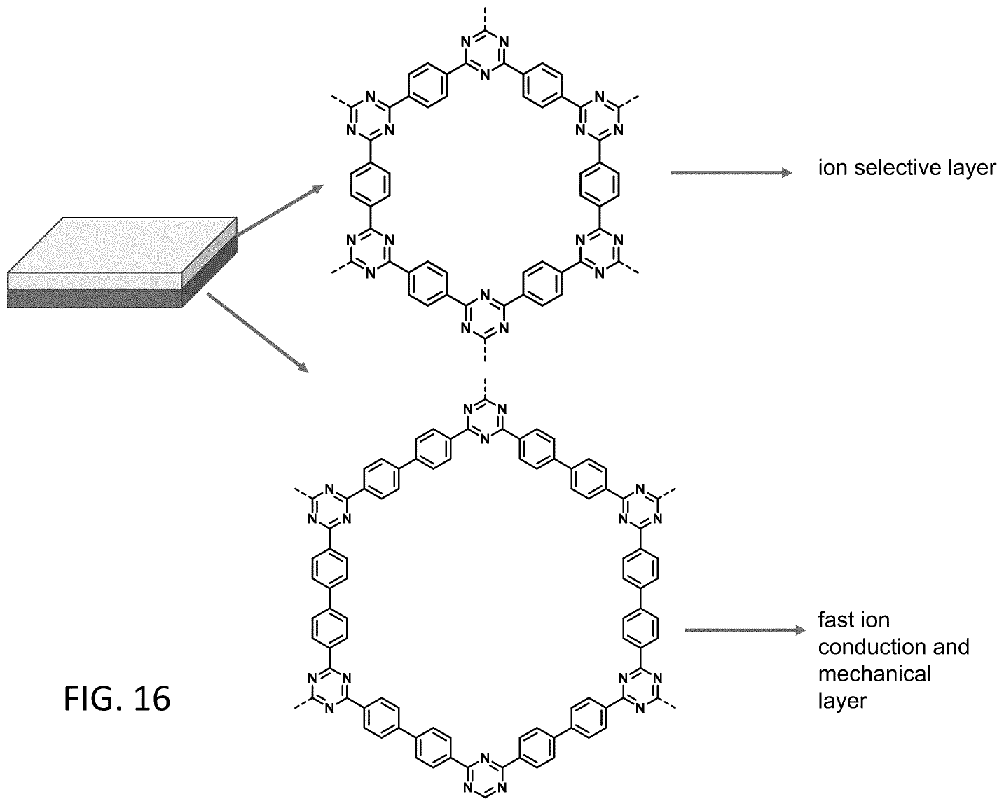

Free-standing GOFIMs can include a single layer of a GOF or can include two or more layers of different GOFs. Multilayered membranes can be formed by carrying out the step-wise condensation of a second GOF on a previously formed layer comprising the GOF. The step-wise condensation reactions are conducive to the fabrication of stable multilayered membranes because crosslinking occurs between adjacent layers of GOF within the membrane, which stabilizes the layers against delamination. The use of multiple layers of the GOFs is advantageous because it allows for the overall properties of the free-standing, multilayered membrane to be tailored by combining GOFs having different properties. FIG. 16 illustrates the use of a double layered free-standing GOFIM that includes a first layer of a GOF having a relatively large average pore size adjacent to, and covalently crosslinked with, a second layer of a GOF having a smaller average pore size. In this double-layer design, the first layer provides for fast ion conduction and mechanical stability, while the second layer provides for high ion selectivity.

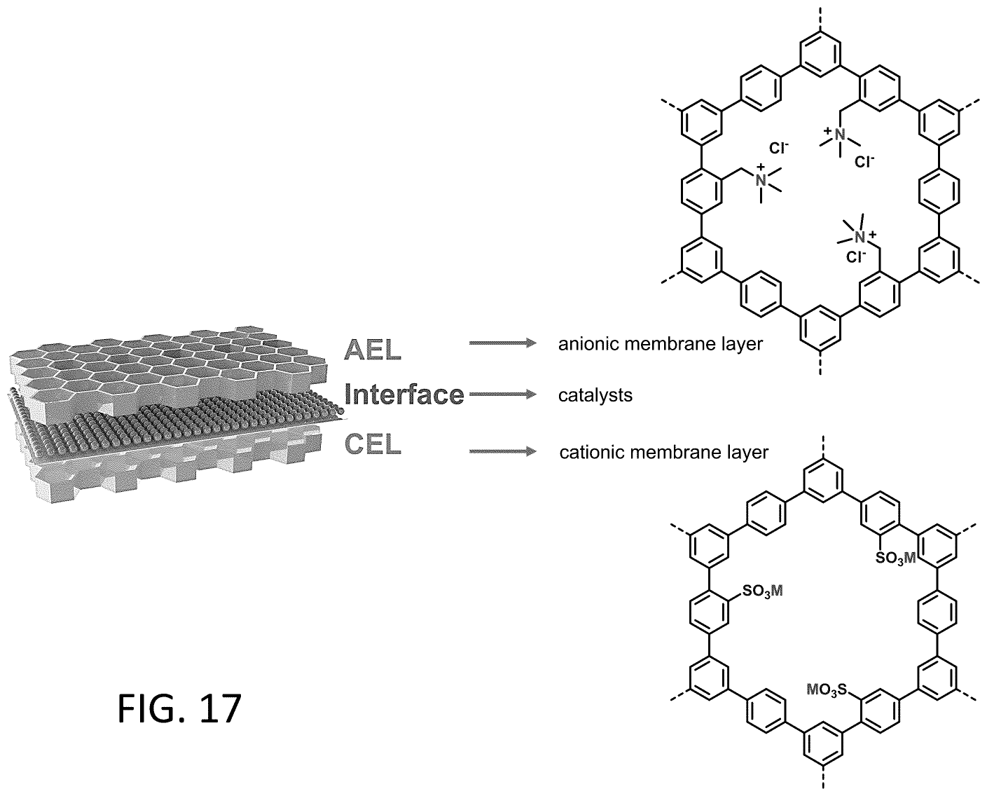

In other embodiments of the multilayered structures, the layers of GOFs are separated by an intervening layer that is not a GOF. The nature of the intervening layer will depend on the intended application. For example, by pairing a cationic GOFIM (c-GOFIM) with an anionic GOFIM (a-GOFIM) in a multilayered structure, a bipolar GOFIM (bp-GOFIM) structure can be constructed. By way of illustration, as shown schematically in FIG. 17, a by-GOFIM structure may include a c-GOFIM and an a-GOFIM separated by a layer comprising a water dissociation catalyst material. Such a membrane design may be used as, for example, a bipolar membrane in an electrochemical cell for water dissociation. Such a cell can be fabricated by laminating a free-standing a-GOFIM (i.e., as an anion exchange layer; AEL) to one surface of a water dissociation catalyst layer and laminating a free-standing c-GOFIM (i.e., as a cation exchange layer; CEL) to an opposing surface of the catalyst layer.

Although the membranes described herein can be fabricated and utilized in a free-standing form, they can also be incorporated into a composite membrane comprising one or more layers of GOF on a base layer, where the nature and purpose of the base layer will depend on the intended application. Generally, the base layer is itself a porous layer, such as a macro-porous layer. Examples of base layers include carbon fiber paper, glass fiber mats, a porous polymer layer, such as a porous polyolefin (e.g., polypropylene or polyethylene), porous polyethylene terephthalate, porous polyimide, including partially carbonized porous polyimide, or a porous polyacrylonitrile layer, porous alumina, and a graphene or graphene oxide layer.

The free-standing GOFIMs and composite GOFIMs have applications in a variety of different devices in which ions are separated or excluded based on their size and/or charge. Such devices include electrochemical and non-electrochemical ion separation devices. In the devices, the GOFIMs may be disposed at any interface where it is desirable to selectively pass or exclude certain ions based on their size and/or charge. If a device has more than one such interface, the device may include GOFIMs at one, some, or all of said interfaces. In an electrochemical cell, such interfaces would include the interface between two different electrolyte solutions or the interface between a solid electrode surface and an electrolyte solution. The electrolyte solutions will include at least one ion and will commonly include more than one ion. The ions may be redox active ions (i.e., anions and/or cations that undergo oxidation and/or reduction reactions during the operation of an electrochemical cell), non-redox active ions, or charge-balancing ions.

In some embodiments of the devices, a GOFIM separates an anolyte solution and a catholyte solution in an electrochemical device. The basic components of such an electrochemical device include an anode, an anolyte in contact with the anode, a cathode, a catholyte in contact with the cathode, a GOFIM of a type described herein, separating the anolyte and the catholyte and an external wire or circuit connecting the anode to the cathode. Electrochemical cells that incorporate the GOFIMs are characterized by long lifetimes with little capacity decay and high energy efficiencies.

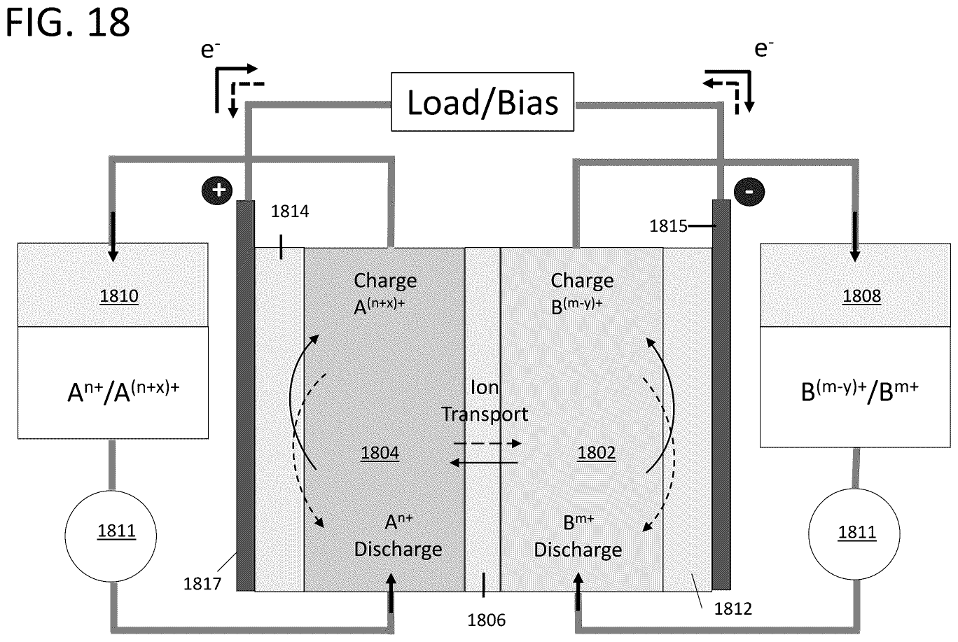

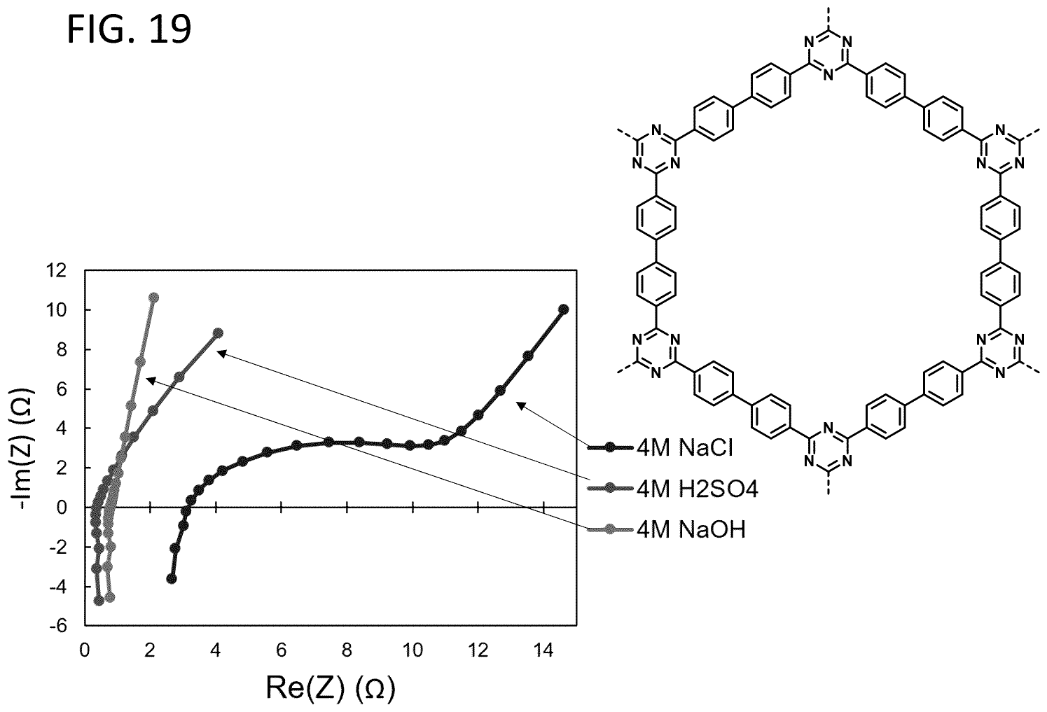

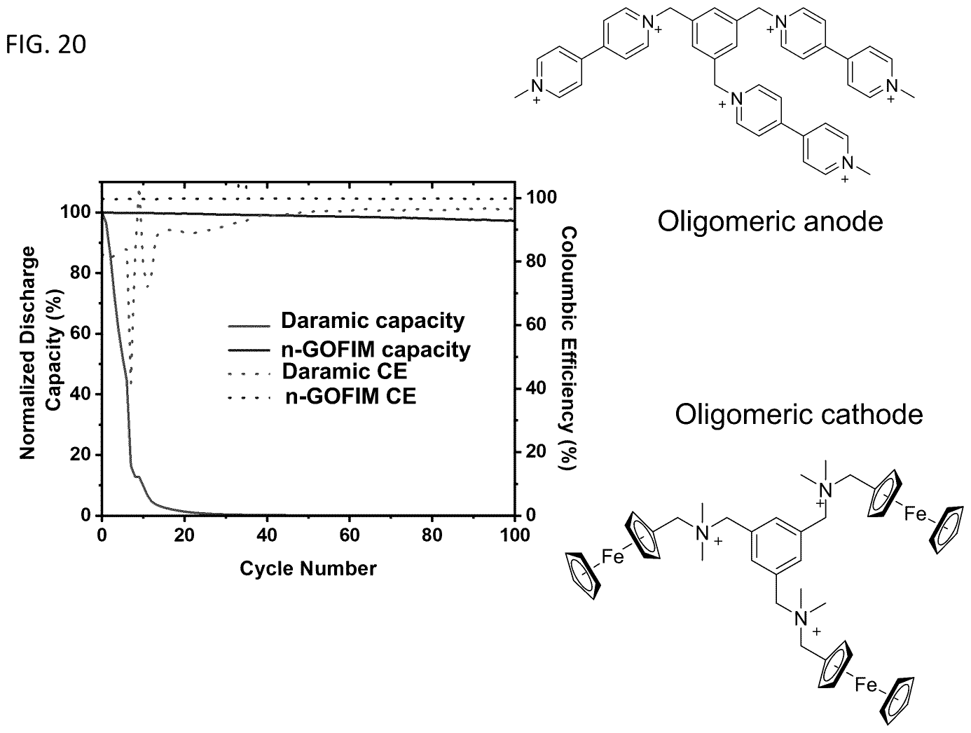

One embodiment of an AORFB that includes a GOFIM is shown schematically in FIG. 18. In the AORFBs, redox-active chemical species are dissolved in aqueous supporting electrolyte solutions where they serve as anode and cathode electrolytes. These anode and cathode electrolytes, which are referred to as anolytes and catholytes, respectively, may be contained in an anode cell compartment 1802 and a cathode cell compartment 1804. For simplicity, in FIG. 18 the anolytes are represented generically as “B”, the catholytes are represented generically as “A”, the charge on the anolyte in its oxidized and reduced states is represented by m+ and (m−y)+, respectively, and the charge on the catholyte in its oxidized and reduced states is represented by (n+x)+ and n+, respectively. A GOFIM 1806 separates anode cell compartment 1802 from cathode cell compartment 1804.

During the charge-discharge process, the redox-active anolyte and catholyte are stored in an anolyte reservoir 1808 and a catholyte reservoir 1810, respectively. Reservoirs 1808 and 1810 are in fluid communication with their respective cell compartments 1802 and 1804, such that the anolyte and catholyte can be circulated through the cell compartments. This circulation can be accomplished using, for example, a pump 1811. During the charging process, a bias is applied across an anode 1812 in anode cell compartment 1802 and a cathode 1814 in cathode cell compartment 1804. As shown in FIG. 18, an anode current collector 1815 and a cathode current collector 1817 can be used to provide electrical conduction between the electrodes and an external circuit. During the charging process, as the anolyte passes over anode 1812, the anolyte molecules undergo electrochemical reduction reactions, while the catholyte molecules passing over cathode 1814 undergo electrochemical oxidation reactions. During the discharge process, the anolyte molecules undergo electrochemical oxidation reactions, while the catholyte molecules passing over cathode 1814 undergo electrochemical reduction reactions to power a load that is connected across anode 1812 and cathode 1814.

A variety of redox species can be used as anolytes and catholytes. These include redox active organic species, metals and metal ions, metal-organic complexes, redox active gases, and other redox active inorganic species. Specific examples include, but are not limited to, phenazine, phenothiazine, fluorenone, naphthalenediamide, viologens, sulfides, 2,2,6,6-tetramethylpiperidin-1-yl)oxyl (TEMPO), TEMPO derivatives, ferrocene, ferrocyanide, alloxazine molecules, iron, bromide, iodide, vanadium, zinc, nicotinamide-adenine-dinucleotide phosphate (NADP), radialene, water (e.g., in a hydrogen evolution reaction (HER) or oxygen evolution reaction (OER)), lithium, sodium, potassium, and aluminum.

Viologen derivatives, such as bis(3-trimethylammonio)propyl viologen tetrachloride, and other pyridyl derivatives, such as those described in U.S. provisional patent application Ser. No. 63/183,162 and shown in FIG. 32 (“Dex-Vi”) of U.S. provisional patent application Ser. number 63/183,162, are particularly attractive for AORFBs that operate at or near pH neutral conditions because they have redox potentials close to the thermodynamic hydrogen evolution reaction potential for water (−0.41 V vs SHE). Thus, because TEMPO oligomers having redox potentials at or near the thermodynamic oxygen evolution reaction potential for water (0.82 vs SHE) can be made using the methods described herein, pairing TEMPO oligomers with pyridyl derivatives allows one to take advantage of the full electrochemical potential window for an AORFB.

The supporting electrolyte solutions typically include chemical species (e.g., salts) that are not electroactive in the AORFB' s range of applied potentials, but have high ionic strengths and, therefore, contribute to the conductivity of the solution. Common supporting electrolytes include sodium chloride (NaCl) and potassium hydroxide (KOH).

### EXAMPLES

### Example 1: Formation of a Free-Standing GOFIM from a Mixed Nitrile/Acetyl Monomer

A quantity of 1 mL of CF₃SO₃H (triflic acid; trimerization catalyst) was added to 0.15 g of 4-acetylbenzonitrile at room temperature under stirring. The viscous solution was stirred for 0.5 h, then drop cast onto a plain precleaned glass and allowed to spread into a thin film. Then, the glass was put on the hot plate preheated to 120° C. for 30 min. A flexible free-standing membrane was successfully formed on the glass surface. The membrane was then quenched in cold water and submerged in the water to release the membrane. The free-standing membrane was immersed in 0.1 M NaOH solution overnight to remove the excess CF₃SO₃H. After the membrane was washed with water and ethanol several times, the membrane was then stored in the deionized (DI) water for further use.

### Example 2: Ionic Conductivity and Electrochemical Performance of a Free-Standing GOFIM.

n-GOFIM Fabrication:

A quantity of 1 mL of CF₃SO₃H was added to 0.1 g of the 4,4-biphenyldicarbonitrile at 0° C. under vigorous stirring. The viscous solution was then stirred for 40 min, followed by drop casting onto a plain precleaned petri dish, where the solution was allowed to spread into a thin layer. Then, the petri dish was sealed with Teflon tape and stood for 0.5 h. The membrane was then quenched in water and immersed in 0.5 M NaOH for 24 h to remove the CF₃SO₃H. After the membrane was washed with water and ethanol several times, the membrane was stored in acetonitrile for further use.

Flow Battery Conditions:

A redox flow battery was constructed and utilized 0.1 M of viologen trimer and 0.1 M of ferrocene trimer in acetonitrile with LiTFSI a as supporting salt. The results showed that the n-GOFIM had comparable cycling stability and efficiency under the same electrolyte conditions as a conventional Daramic membrane.

Electrochemical Impedance Spectroscopy:

c-GOFIM films of different percent of charge dopants were prepared. The ion mobility resistance of the films was measured using a pinch test with aqueous NaCl and H₂SO₄ electrolytes, respectively.

### Example 3: Synthesis of a Free-Standing c-GOFIM and Characterization Thereof

Synthesis of acetylmethanesulfonate:

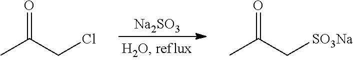

Quantities of 31.4 g of sodium sulfite and 20 mL of chloroacetone (Equiv. molar ratio) were added to 100 mL of water. Then, the mixture was refluxed for 24 h. After cooling to room temperature, the residual solvents were evaporated on a rotary evaporator. The white reaction product was dissolved in 250 mL of ethanol at 60° C. and filtered to remove salts. The solution was evaporated again and dried in a vacuum oven at room temperature.

Synthesis of cyanomethanesulfonic acid:

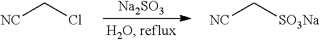

A quantity of 10 mL of chloroacetonitrile and 19.66 g of sodium sulfite (Equiv. molar ratio) was added to 200 mL of water. Then, the mixture was refluxed for 24 h. After cooling to room temperature, the residual solvents were evaporated on a rotary evaporator.

Fabrication of a free-standing GOFIM:

A quantity of 1 mL of CF₃SO₃H was added to 0.2 g of the 1,4-dicyanobenzene at room temperature under vigorous stirring. The viscous solution was stirred for 20 min, then drop cast onto a plain precleaned petri dish and allowed to spread into a thin layer. Then, the petri dish was sealed with Teflon tape and stood for 72 h. The membrane was then quenched in water and immersed in 0.5 M NaOH for 24 h to remove the CF₃SO₃H. After the membrane was washed with water and ethanol several times, the membrane was then stored in the deionized (DI) water for further use.

Fabrication of a composite n-GOFIM:

The monomer 1,4-diacetylbenzene (120 mg) was first dissolved in 1 mL CF₃SO₃H to form a homogeneous solution. The glass fiber (Celgard or porous polyimide) was attached in a micro cover glass, then the solution was drop casted onto the glass fiber and sandwiched by another micro cover glass. This sandwich system was heated at 120° C. for 12 h. After cooling down to room temperature, the composite GOFIM was separated from the cover glass by immersing in DI water. The membrane was then quenched in water and immersed in 0.5 M NaOH for 24 h to remove the CF₃SO₃H. After the composite GOFIM was washed with water and ethanol three times, the membrane was then stored in the DI water for further use.

Fabrication of a c-GOFIM:

The 0.2 g of acetylmethanesulfonate and 1,4-dicyanobenzene mixture (5, and 10 wt. %) were used as precursors for the synthesis of a sulfonate-functionalized GOF. The viscous solution was stirred for 30 and 50 min, respectively. The subsequent process was the same as the process used to synthesize the GOFIM from the pristine 1,4-dicyanobenzene monomer. A more flexible GOFIM was obtained.

Ionic Conductivity

The ionic conductivity of the GOFIMs was measured using electrochemical impedance spectroscopy. The membranes were soaked in 4 M NaCl or 2 M H₂SO₄ for 24 h prior to measurement. The membranes were sandwiched between stainless steel electrodes. The ionic conductivity was calculated by the following equation: σ=L/(Rₘ×A), where Rₘ is the membrane resistance, A is the active membrane area (2 cm²), and L is the membrane thickness. The results are shown in the table below.

| | | | c-GOFIM- | c-GOFIM- |
|---|---|---|---|---|
| Electrolyte | | GOFIM-0 | 5% | 10% |
| 4M NaCl | Thickness (um) | 23 | 90 | 110 |
| | Rₘ | 0.294 | 0.371 | 0.332 |
| | Conductivity | 3.92 | 12.1 | 16.6 |
| | (mS/cm) | | | |
| 2M H₂SO₄ | Thickness (um) | 24 | 52 | 102 |
| | Rₘ | 0.16 | 0.16 | 0.24 |
| | Conductivity | 7.5 | 16.3 | 21.3 |
| | (mS/cm) | | | |

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” can mean only one, or can mean “one or more.” Embodiments consistent with either construction are covered.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An electrochemical cell comprising:
(a) an anode;
(b) a first electrolyte solution comprising redox inactive ions, redox active ions, or a mixture thereof;
(c) a cathode;
(d) a second electrolyte solution comprising redox inactive ions, redox active ions, or a mixture thereof and
(e) at least one ion-conductive membrane comprising a continuous, unitary, homogeneous sheet of a glassy organic framework, the at least one ion-conductive membrane separating (a) and (b), separating (b) and (d), or separating (c) and (d), the glassy organic framework comprising a network of covalently bonded aromatic rings, wherein the aromatic rings comprise phenylene rings, 1,3,5-triazine rings, pyridine rings, pyrimidine rings, or a combination of two or more thereof.

2. The electrochemical cell of claim 1, wherein the ion-conductive membrane is a free-standing membrane.

3. The electrochemical cell of claim 1, wherein the ion-conductive membrane is a composite membrane comprising the continuous, unitary, homogeneous sheet of the glassy organic framework on a substrate.

4. The electrochemical cell of claim 1, wherein the aromatic rings are functionalized with one or more cationic groups.

5. The electrochemical cell of claim 1, wherein the aromatic rings are functionalized with one or more anionic groups.

6. The electrochemical cell of claim 1, wherein the aromatic rings are functionalized with one or more halogen atoms.

7. The electrochemical cell of claim 1, wherein the aromatic rings comprise the phenylene rings.

8. The electrochemical cell of claim 7, wherein the phenylene rings are directly covalently bonded to one another.

9. The electrochemical cell of claim 7, wherein the phenylene rings are covalently bonded to one another via an alkane chain or an alkene chain.

10. The electrochemical cell of claim 1, wherein the aromatic rings comprise the 1,3,5-triazine rings.

11. The electrochemical cell of claim 10, wherein the 1,3,5-triazine rings are directly covalently bonded to one another.

12. The electrochemical cell of claim 10, wherein the 1,3,5-triazine rings are covalently bonded to one another via an alkane chain or an alkene chain.

13. The electrochemical cell of claim 10, wherein the 1,3,5-triazine rings are covalently bonded to one another via a carbazole group, a pyridinium group, or a bipyridinium group.

14. The electrochemical cell of claim 1, wherein the aromatic rings comprise the phenylene and 1,3,5-triazine rings.

15. The electrochemical cell of claim 14, wherein the phenylene and 1,3,5-triazine rings are directly covalently bonded to one another.

16. The electrochemical cell of claim 1, wherein the first electrolyte solution and the second electrolyte solution are aqueous solutions.

17. The electrochemical cell of claim 1, wherein the first electrolyte solution is an anolyte solution comprising one or more redox active anolytes and the second electrolyte solution is a catholyte solution comprising one or more redox active catholytes.

18. The electrochemical cell of claim 17, wherein the at least one ion-conductive membrane separates the anolyte solution from the catholyte solution.

19. The electrochemical cell of claim 17, wherein the electrochemical cell is an aqueous organic redox flow battery.

20. A method of making an ion-conductive membrane, the method comprising:
dissolving monomers in a trimerization reaction catalyst to form a solution, the monomers comprising: a nitrile monomer having one or more nitrile groups; an acetyl monomer having one or more acetyl groups; a monomer having at least one nitrile group and at least one acetyl group; a nitrogen-containing aromatic heterocyclic monomer comprising a functional group on a ring nitrogen atom in addition to at least two nitrile functional groups;
or a combination of two or more thereof, and, optionally, a charged monofunctional dopant monomer comprising a single nitrile group or a single acetyl group, wherein the monomers react to form intermediates dissolved in the solution;
forming a film of the solution on a surface of a substrate; and
heating the film to induce a reaction of the intermediates to form the ion-conductive membrane comprising a continuous, unitary, homogeneous sheet of a glassy organic framework comprising a network of covalently bonded phenylene rings, 1,3,5-triazine rings, pyridine rings, pyrimidine rings, or a combination thereof.
